(19) United States
(12) Patent Application Publication
(10) Pub. No.: US 2006/0013746 A1
(43) Pub. Date: Jan. 19, 2006

(54) Exhaust system

(75) Inventors: Wilfried Bien, Seevetal-Emmeldorf (DE); Jan Peter Elfeldt, Hamburg (DE); Frank Engel, Ebersbach (DE); Michael Halves, Hamburg (DE); Thomas Huelsberg, Buchholz (DE); Uwe Kluessmann, Bispingen (DE); Holger Nuhn, Schneverdingen (DE); Ralf Puenjer, Seevetal/Fleestedt (DE); Olav Reinhardt, Hamburg (DE); Dirk Riewert, Hamburg (DE); Alfred Riggers, Freetz-Lengenbostel (DE); Thorsten Sternal, Moisburg (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuttgart (DE)

(21) Appl. No.: 11/107,777

(22) Filed: Apr. 18, 2005

(30) Foreign Application Priority Data
Apr. 17, 2004 (DE) 10 2004 018 693.6

(51) Int. Cl. B01D 53/34; F01N 3/28

(52) U.S. Cl. 422/179; 422/177

(57) ABSTRACT

The invention relates to an exhaust system comprising exhaust pipes, through which hot gas flows and which are connected on the inlet side to a cylinder head of an internal combustion engine, and comprising at least one catalyst support element, attached to at least one exhaust pipe. To make it possible to use a catalyst support element close to the engine without affecting the engine compartment with respect to the available space, it is proposed that the catalyst support element exhibits a cross section that is largely identical to that of the exhaust pipes and forms, as a replacement, at least one section of an exhaust pipe.

This application claims the priority of German Patent Application No. 10 2004 018 693.6-13, filed Apr. 17, 2004, the disclosure of which is expressly incorporated by reference herein.

### BACKGROUND AND SUMMARY OF THE INVENTION

The invention relates to an exhaust system.

DE 102 16 272 A1 discloses an exhaust system of this class. The prior art exhaust system exhibits an exhaust pipe, to the end of which is molded an annular collar-like flange, by means of which the exhaust pipe is screwed to the cylinder head of an internal combustion engine with intercalation of a seal. The exhaust pipe is expanded cylindrically in the direction of the exhaust outlet opening of the cylinder head. The cylindrical expansion receives, like a housing, a catalyst support element, which is braced elastically by means of jackets and wire woven sleeves. The catalyst support element is formed in the shape of a tube and contains a catalyst monolith. Of course, the prior art exhaust system guarantees that the catalyst will light off faster because of the catalyst's proximity to the engine, but, first of all, its arrangement is relatively complicated and thus cost intensive. Secondly, the housing-like, cylindrical expansion of the exhaust pipe for receiving the catalyst support element requires an enlarged working space, which is only rarely available in modern engines.

Furthermore, DE 197 18 853 A1 discloses a cast exhaust manifold, where after conjoining several exhaust pipes an expanded section is cast that serves as the housing for a catalyst. In so doing, an exhaust inlet funnel and an exhaust outlet funnel are formed jointly on the housing-like expansion. Such an exhaust manifold is not only heavy, but also requires an enlarged working space in order to receive the catalyst. Furthermore, the arrangement of the catalyst in the aforementioned expansion can be realized only with difficulty because the expansion with the exhaust pipes and the funnels is made as one piece, so that without cutting open the expansion the catalyst must also be integrated into the casting process. The temperatures during the casting process and the material distortions during the hardening process of the liquid casting material can result in the degradation of the catalyst and consequently a loss of function.

Furthermore, DE 199 18 301 C1 discloses a subsystem of an exhaust system for a motor vehicle, which is designed so as to be air gap-insulated and encloses a catalyst element. The catalyst is provided with a housing, which is disposed between two exhaust pipes and comprises an outer jacket and an inner jacket, which is spaced apart from said outer jacket. The inner jacket is attached to an exhaust inlet funnel and an exhaust outlet funnel, both of which are connected to hot gas-guiding inner pipes of the exhaust system. In the area of the said funnels the shape of the outer jacket is adapted to said funnels. Even the exhaust system disclosed here requires an increased working space requirement due to the catalyst and its housing so that in the case of tight engine compartments the design of such an exhaust system cannot achieve results. Owing to the many individual parts, which are necessary for constructing such an exhaust system, especially for forming the air gap-insulated catalyst support element, the production and assembly costs are quite sizeable.

The invention is based on the problem of improving an exhaust system of this class to the effect that it is possible to utilize in a simple way a catalyst support element in the vicinity of the engine without affecting the engine compartment with respect to the available space.

The invention solves this problem by means of the features of patent claim 1.

The invention is based on the basic idea of integrating one or more catalyst support element(s) in the run of an exhaust system without changing its design. For this purpose the catalyst support element exhibits, according to the invention, a cross section that is largely identical to that of the exhaust pipes of the exhaust system and forms, as a replacement, at least one section of an exhaust pipe. Since the appearance of the exhaust system, according to the invention, cannot be distinguished from the exhaust system without a catalyst support element, the surrounding engine compartment is not affected by any possible tightness, which the catalyst support element normally brings with it. Thus, even in the case of close working spaces the exhaust system, according to the invention, can be utilized in a simple way with a catalyst support element, which is mounted close to the engine. The exhaust system, according to the invention, is characterized by its design simplicity, because it dispenses with supplementary parts. Since the catalyst support element has no inlet and outlet funnels, which cause turbulence in the hot gas flow of the exhaust gas and thus lead to a high flow resistance, which reduces the power for the engine, said flow resistance is very low here. Since in the exhaust system, according to the invention, no supplementary parts are necessary and even a special design of a housing receiving the catalyst support element ceases to be applicable, the exhaust system is very economical. As a consequence of the simple replacement of sections of the exhaust pipes by the catalyst support element, said catalyst support element can be mounted especially close to the engine, thus improving the light-off behavior of the catalyst.

In an especially preferred further development of the invention, according to claim 2, the exhaust system contains an exhaust manifold, which comprises at least two exhaust pipes. The exhaust manifold's pipe sections, which point in the direction of the input flanges, fastened to the cylinder head, are shortened so as to resemble stubs. In addition, each catalyst support element is fastened, as an extension of the pipe sections, to the pipe sections, on the one hand, and to the input flanges, on the other hand. In this way the catalyst support element is mounted especially close to the engine, a state that leads to an even greater increase in the light-off rate of the catalyst. In addition, mounting the catalyst support elements is quite simple, because each one forms the end of the exhaust pipes so that they need only be mounted on the ends of the pipe sections and welded, glued or soldered so as to form a circumferential weld. As an alternative, spot welding or also a full joining method would be conceivable. On the other end the catalyst support elements need be fastened only to the respective input flange. The arrangement of several catalyst support elements on the individual pipe sections of the exhaust pipes results altogether in a very large catalyst volume, a feature that surpasses by far the volume of a single, large prior art catalyst that requires additional working space. In this way the exhaust emission control is also improved and is more efficient. Owing to the short stub-like pipe sections, the exhaust pipes can be produced more economically by internal high pressure metal forming, because this method is more expedient and faster precisely for short extension lengths. Simultaneously extremely high qualities of the connecting areas on the catalyst support element are obtained so that owing to the freedom of tolerance targeted for these connecting areas, very strong fastening connections with the catalyst support element are achieved. The exhaust pipes can be connected together by plug connections by way of sliding seats or as one piece.

In a preferred further development of the invention, according to claim 3, the exhaust manifold, according to claim 2, is air gap-insulated. The catalyst support element, which forms the elongation of the respectively shortened, hot gas-guiding, enclosed pipe section, is fastened to the outer jacket of the exhaust manifold in the input flange area. Said outer jacket is air gap-insulated and envelops said pipe section at a distance. As a consequence of the air gap insulation of the exhaust manifold by means of the outer jacket, which can be formed by a shell shape or by individual pipe sections, the light-off rate of the catalyst is further increased. To optimize the gas tightness of the air gap insulation, the catalyst support element in the borehole of the respective input flange is connected gas-tight to the outer jacket of the exhaust manifold. Since the catalyst support element forms an elongation of the enclosed pipe section, the catalyst support element and thus the catalyst is also air gap-insulated, a feature that is largely in agreement with its mode of functioning. In contrast to the related background art (DE 199 18 301 C1), one can dispense with increased assembly complexity because the catalyst support element is housed inside the outer jacket.

In another advantageous design of the inventive exhaust system, according to claim 4, the exhaust pipes are connected together by the catalyst support element, which bridges the axial distance between the exhaust pipes. The design is especially optimal when the pipe routing of the exhaust system is very complicated, i.e. has multiple bends, so that several exhaust pipes are connected together. In so doing, after shortening one or both of the exhaust pipe(s), to be connected, the catalyst support element is inserted in a simple way between the two exhaust pipes and connected rigidly to them. Owing to the multiple divisions of the exhaust pipe routing into many individual pipe sections a very large number of catalyst support elements can be integrated into the exhaust system. The result is an especially large catalyst volume.

According to a further development of this design, according to claim 5, the catalyst support element is fastened, on the one hand, to one of the exhaust pipes, and is guided, on the other hand, in the sliding seat on the other exhaust pipe. This is based on the condition that the other end of the exhaust pipe, which forms the sliding seat, has a fixed bearing, for example, on the input flange or also on the output flange. The exhaust pipe, on which the catalyst support element is fastened, is also securely fastened on the other end to a flange. The result of the formation of a sliding seat is that while the engine is running, the larger thermal expansion, which would otherwise lead to the formation of cracks and a failure of the exhaust pipe connection, can be compensated in a simple way.

Another favorable further development of the exhaust system, according to the invention, is shown in claim 6. In this further development the exhaust pipes and the catalyst support element are air gap-insulated. In this respect the outer jacket, which envelops at a distance the hot gas-guiding exhaust pipes, extends simultaneously beyond the catalyst support element. This means an especially simple air gap insulation of the exhaust pipes with as little assembly complexity as possible. Since the catalyst support element is also air gap-insulated, a cold bridge is avoided in the area of the gap between the exhaust pipes, which the catalyst support element bridges. Even though the catalyst support elements are not arranged directly in the flange area, the air gap insulation produces an improved light-off behavior of the catalyst.

In a preferred further development of the design of the invention according to claim 6, according to claim 7, the outer jacket comprises individual outer pipes, which are rigidly connected together. The formation of the outer jacket by outer pipes takes into account the tight engine compartments, since owing to the outer pipes adapting to the shape of the enclosed hot gas-guiding pipes, the exhaust system can be designed slimmer. In so doing, one single outer pipe bridges at least one enclosed pipe and the catalyst support element in a way that decreases the number of components, so that a separate outer pipe in the bridging area of both of the enclosed exhaust pipes, to be connected, can be dispensed with.

In another preferred further development of the inventive exhaust system according to claim 8, the enclosed exhaust pipes are fastened with their ends, facing away from the catalyst support element, to the respective ends of the respectively enveloping outer pipes. Even though these places can develop a cold bridge, the enclosed exhaust pipe and thus also the catalyst support element are given a rigid hold and a defined position within the air gap insulation.

In a preferred design of the inventive exhaust system according to claim 9, the system contains at least two successive catalyst support elements, which interlock by way of a sliding seat. In this respect a first catalyst support element is rigidly connected to the subsequent end of the one exhaust pipe, and a second catalyst support element is rigidly connected to the subsequent end of another exhaust pipe. Owing to this design simultaneously two exhaust pipe sections, which lie directly in series and which form the inner pipes of the air gap-insulated exhaust system, are replaced simultaneously by two catalyst support elements on a straight-line, longer run of the exhaust system. In so doing, an especially large catalyst volume is realized in the narrowest space, without any negative impact on the surrounding working space of the exhaust system. The sliding seat enables better compensation for the thermal expansion on the longer straight run of the exhaust system. Furthermore, the catalysts can be mounted in a simple way because, in contrast to a one-piece straight inner pipe, access to the interior of each individual catalyst support element before assembling into a sliding seat is guaranteed.

In another especially preferred further development of the invention, according to claim 10, at least one of the catalyst support elements is located inside a hollow expanding body, which is a part of the outer jacket of the air gap-insulated exhaust system. This makes it possible to compensate for the thermal expansion, which develops when the motor is running, not only by means of the inner pipes but also by means of the outer jacket. In this respect the sliding seat of the enclosed catalyst support elements makes it possible to change the length of the expanding body.

Other objects, advantages and novel features of the present invention will become apparent from the following detailed description of the invention when considered in conjunction with the accompanying drawings.

### BRIEF DESCRIPTION OF THE DRAWINGS

FIG. 1 is a perspective view of an inventive exhaust system with an exhaust manifold and several catalyst support elements, joined to the input flange.

FIG. 2 is a perspective view of a longitudinal sectional view of an inventive air gap-insulated exhaust system with catalyst support elements, which bridge with a gap the enclosed exhaust pipes.

FIG. 3 is a longitudinal sectional view of an inventive exhaust system comprising catalyst support elements, which are connected together by means of a sliding seat, and comprising an expanding body, which envelops the catalyst support elements and which belongs to the outer jacket of the exhaust system.

### DETAILED DESCRIPTION OF THE DRAWINGS

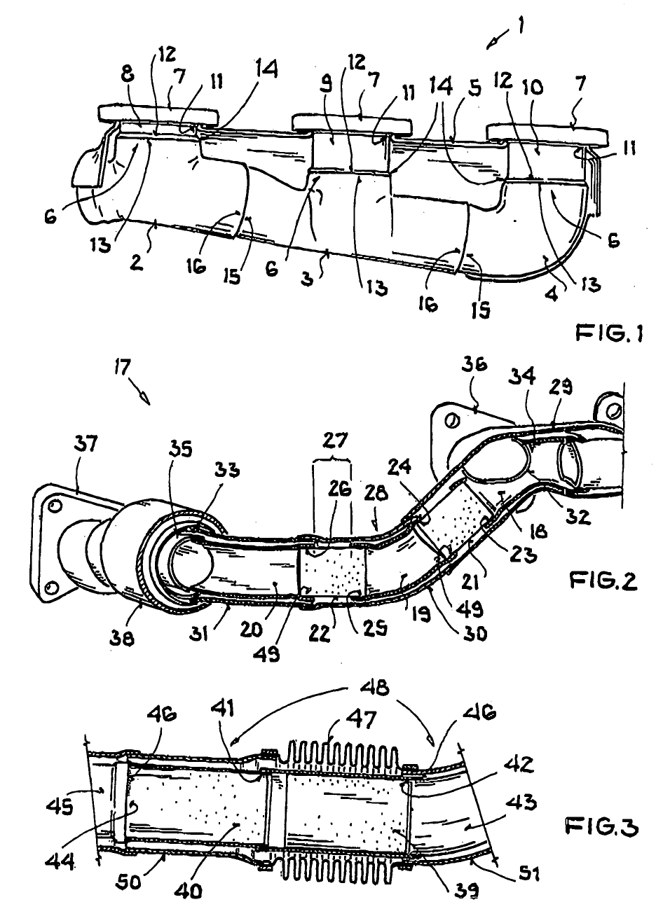

FIG. 1 depicts an exhaust manifold 1 of an exhaust system, which comprises three exhaust pipes 2, 3 and 4, through which hot gas flows. Whereas the exhaust pipes 2 and 3 are designed as T-pieces, the exhaust pipe 4 is formed by a pipe elbow. The exhaust manifold 1 is designed air gap-insulated and thus contains an outer jacket 5, which is constructed here like a dish. The outer jacket 5 is spaced as far apart as possible from the exhaust pipes 2, 3 and 4 so as to form an air gap. The exhaust pipes 2 to 4 form the inner pipes of the exhaust manifold 1.

The exhaust pipes 2 to 4 exhibit pipe sections 6, which are oriented so as to align with the input flanges 7, by means of which the exhaust manifold 1 is fastened to a cylinder head. The pipe sections 6, which are normally connected directly to the input flanges 7, are shortened like stubs, according to the invention. The exhaust pipes 2 to 4 can be parts, formed by internal high pressure metal forming. The shortened stub-like pipe sections 6 of the exhaust pipes 2 and 3 are extensions, produced by the internal high pressure metal forming method. Since the pipe sections 6 are short, the utilization for forming the exhaust pipes 2 and 3 and/or 4 by internal high pressure metal forming is especially favorable, because there is practically no material thinning with such short extensions, so that the production process can run more expediently. The missing run between the pipe sections 6 and the input flanges 7 is replaced by a cylindrically shaped catalyst support element 8 to 10 respectively, which is rigidly connected, preferably however welded, on one end 11 to both the outer jacket 5 of the exhaust manifold 1 and to the input flanges 7. The opposite end 12 of the catalyst support element 8 to 10 is welded to the end 13 of the pipe sections 6 so as to form a circumferential weld.

Prior to welding, the sheet metal catalyst support element 8 to 10 can be just simply mounted on the end 13 of the pipe sections 6 or can be inserted into said end up to a specific depth. The inserted section of the catalyst support element 8 to 10 acts as the guide element for the incoming exhaust gas, a feature that prevents to some degree backpressure building up in the exhaust gas due to turbulence. The catalyst support element 8 to 10 does not have to be welded necessarily to the end 13 of the pipe sections 6, but rather can also be connected to them by soldering or by full joining. Even though the outer jacket 5 is formed here in the shape of a shell, which envelops all of the exhaust pipes 2 to 4 in their entirety, said outer jacket can also comprise individual outer pipes, which are rigidly connected together and which can be produced from a sheet by deep drawing and subsequent winding or folding.

The catalyst support element 8 to 10, which forms the elongation of the pipe sections 6 up to the input flanges 7 and in so doing replaces a section of the exhaust pipes 2 to 4, largely exhibits the same cross section as the exhaust pipes 2 to 4. The catalyst support element 8 to 10, which comprises a sheet metal cylinder, encloses a catalyst, which is fastened to it and which can be made of metal or a ceramic monolith. To guarantee that the catalyst support element 8 to 10 is securely attached to the input flanges 7 and to the pipe sections 6 as well as to prevent the catalyst from being degraded during the fastening process, said catalyst is housed in the catalyst support element 8 to 10 in such a manner that it is adequately spaced axially from the end 11 and 12 of the catalyst support element 8 to 10. Moreover, the enclosed exhaust pipes 2 to 4 are interlocked in a sliding seat with at least one end 15 and 16, facing away from a catalyst support element, so that the thermal expansion, which has an impact in the axial direction, can be compensated.

FIG. 2 also shows an exhaust manifold 17 of an exhaust system, which, however, is not so compactly designed, compared to the previous embodiment, but rather exhibits an elongated and twisted run, thus greater complexity. In another variance from the previous embodiment, in the air gap-insulated exhaust manifold 17 the enclosed hot gas-guiding exhaust pipes 18 to 20 are connected together by a respective catalyst support element 21 and 22. The exhaust pipes 18 to 20, the length of which is significantly shortened compared to the conventional exhaust pipes, which are interlocked in the sliding seat, are spaced apart; or rather their ends 23 and 24 or 25 and 26, which face each other, are spaced apart. This axial distance 27 is bridged by the catalyst support elements 21 and 22.

The catalyst support element 21, which exhibits a cross section that is largely identical to the cross section of the exhaust pipes 18-20, is inserted with one section into the end 23 of the exhaust pipe 18 and welded to said end, which forms the inlet side of the exhaust gas for the catalyst support element 21. On the opposite exhaust outlet side the catalyst support element 21 is received with the sliding seat 49 in the end 24 of the exhaust pipe 19 for the purpose of compensating for the thermal expansion. Analogously the catalyst support element 22 is inserted into the end 25 of the exhaust pipe 19 and welded to said end there, whereas on the opposite exhaust outlet side said catalyst support element is received with the sliding seat 49 in the end 26 of the exhaust pipe 20 also for the purpose of compensating for thermal expansion. If the temperature conditions are such that the maximum thermal expansion is only on a small scale, the catalyst support element 21 and 22 can also be welded, instead of the sliding seat 49, to the ends 24 or 26.

Owing to the air gap insulation the exhaust pipes 18 to 20 and the catalyst support elements 21 and 22 are enveloped by an outer jacket 28, which extends beyond both the exhaust pipes and simultaneously beyond the catalyst support element 21 and 22 and comprises individual outer pipes 29 to 31, which are rigidly connected together, preferably welded, and are interlocked in the welding position so that the results of the welding process are circumferential fillet welds. The enclosed exhaust pipes 18 and 20 are fastened, preferably welded, on their end 32 and 33, facing away from the catalyst support element 21 and 22, to the ends 34 and 35, located there and belonging to the respective enveloping outer pipes 29 and 31, especially in the flange region of the input flange 36, adjacent to the outer pipe 29.

Between the input flange 36, which connects the exhaust manifold 17 to a cylinder head of an internal combustion engine, and an output flange 37, which connects the exhaust manifold 17 to that part of the exhaust system that leads to the exhaust, there is an expanding body 38, which connects the outer pipe 31 to the output flange 37, and which serves as the main compensation for the thermal expansion. With respect to the arrangement of the catalyst support elements with their contained catalysts made of metal or a ceramic monolith, it ought to be added here that said arrangement is not limited to an exhaust manifold, but rather is conceivable at any place of the outer pipes of an air gap-insulated exhaust system. Similarly it is also conceivable that the illustrated exhaust manifold 17 is designed without an air gap insulation, a feature that can produce results, of course, only in the areas of engine compartments, where the thermal load is not a factor and does not result in any degradation whatsoever.

Another alternative of the exhaust system, according to the invention, is shown in FIG. 3. The system exhibits a longer straight line pipe run, which is air gap-insulated and contains two catalyst support elements 39 and 40, arranged directly in series. The pipe run can also be a part of an exhaust manifold of the system. The two catalyst support elements 39 and 40, each of which contains a catalyst made of metal or a ceramic monolith and which is formed by a sheet metal cylinder, interlock by way of a sliding seat 41. The first catalyst support element 39 is rigidly connected, preferably welded, to that end 42 of an enclosed air gap-insulated exhaust pipe 43 that adjoins said first catalyst support element; and the second catalyst support element 40 is rigidly connected, preferably welded, to that end 44 of another, also air gap-insulated exhaust pipe 45 that adjoins said second catalyst support element. For this purpose the ends 42 or 44 of the exhaust pipes 43 or 45 are inserted with the enveloping section in the hollow cylindrical catalyst support element 39 or 40 that is made of sheet metal and subsequently welded so as to form a circumferential fillet weld 46. The catalyst support elements 39 or 40 exhibit a cross section that is largely identical to that of the exhaust pipes 43 and 45. The second catalyst support element 40 is located inside a hollow expanding body 47, which is formed as metal bellows and which compensates for the thermal expansion of the exhaust system and which is part of the outer jacket 48 of the air gap-insulated exhaust system. The outer jacket 48 comprises the individual outer pipes 50 and 51, which are welded together, and, as said, the expanding body 47, which bridges an axial gap between two outer pipes 50 and 51 and is rigidly connected to them on both sides. At this point it must be pointed out that the catalyst support elements 39 and 40 can totally replace both conventional hot gas-guiding exhaust pipes in the air gap insulation or, as an alternative, can form sections of them.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. Exhaust system comprising exhaust pipes, through which hot gas flows and which are connected on the inlet side to a cylinder head of an internal combustion engine, and comprising at least one catalyst support element, attached to at least one exhaust pipe, wherein the catalyst support element exhibits a cross section that is largely identical to that of the exhaust pipes and forms, as a replacement, at least one section of an exhaust pipe.

2. Exhaust system, as claimed in claim 1, wherein the exhaust system contains an exhaust manifold, which comprises at least two exhaust pipes, the pipe sections of which point in the direction of the input flanges, which are fastened to the cylinder head and are shortened like stubs; and that each catalyst support element is fastened, as an extension of the pipe sections, to the pipe sections, on the one hand, and to the input flanges, on the other hand.

3. Exhaust system, as claimed in claim 2, wherein the exhaust manifold is air gap-insulated, whereby the catalyst support element, which forms the elongation of the respectively shortened, hot gas-guiding, enclosed pipe section, is fastened to the air gap-insulating outer jacket, which envelops at a distance said pipe section and which belongs to the exhaust manifold in the input flange area.

4. Exhaust system, as claimed in claim 1, wherein the exhaust pipes are connected together by the catalyst support element, which bridges the axial distance between the exhaust pipes.

5. Exhaust system, as claimed in claim 4, wherein the catalyst support element (21, 22) is fastened, on the one hand, to one of the exhaust pipes, and is guided, on the other hand, in the sliding seat on the other exhaust pipe.

6. Exhaust system, as claimed in claim 4, wherein the exhaust pipes and the catalyst support element are air gap-insulated, whereby the outer jacket, which envelops at a distance the hot gas-guiding exhaust pipes, extends simultaneously beyond the catalyst support element.

7. Exhaust system, as claimed in claim 6, wherein the outer jacket comprises individual outer pipes, which are rigidly connected together.

8. Exhaust system, as claimed in claim 7, wherein the enclosed exhaust pipes are fastened with their ends, facing away from the catalyst support element, to the respective ends of the respectively enveloping outer pipes.

9. Exhaust system, as claimed in claim 6, wherein the system contains at least two successive catalyst support elements, which interlock by way of a sliding seat, whereby a first catalyst support element is rigidly connected to the subsequent end of the one exhaust pipe, and a second catalyst support element is rigidly connected to the subsequent end of another exhaust pipe.

10. Exhaust system, as claimed in claim 9, wherein at least one of the catalyst support elements is located inside a hollow expanding body, which is a part of the outer jacket of the air gap-insulated exhaust system.
